(19) United States
(12) Patent Application Publication
(10) Pub. No.: US 2016/0018042 A1
(43) Pub. Date: Jan. 21, 2016

(54) Pressure Sealing Plug

(71) Applicant: Stephen Dean Bair, Kailua-Kona, HI (US)

(72) Inventor: Stephen Dean Bair, Kailua-Kona, HI (US)

(21) Appl. No.: 14/335,904

(22) Filed: Jul. 19, 2014

(51) Int. Cl. F16L 55/11

(52) U.S. Cl. CPC F16L 55/11

(57) ABSTRACT

A pressure plug is disclosed and includes a circular and threaded plate, a flexible sealing collar, a pressure plate, and a T handle. The circular threaded pate receives the bottom edge of the flexible sealing collar in a stepped upward surface, and the pressure plate is placed on top of the sealing collar. The threaded plate has a shaft extended upward from its center and towards a hole in the top pressure plate having an angled surface on its outer bottom face. The T handle is threaded onto the threaded shaft, and as the T handle is tightened the two plates are pulled toward each other. This forces the upper edge of the sealing collar outwardly against the inside diameter of the pipe, thereby creating a seal. By sealing both ends of the pipe, then the heated pipe can be re-shaped, while the contained pressure prevents collapsing or kinking of the pipe.

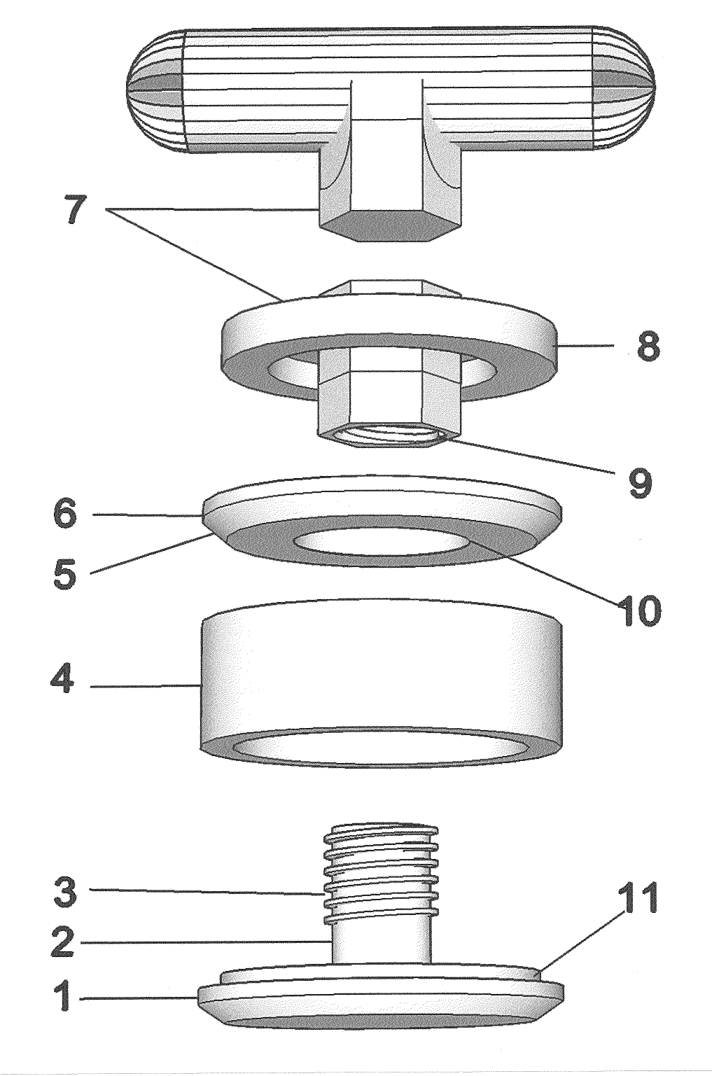

### BACKGROUND

The present invention is related to a reusable, easily installable and removable pressure sealing plug and more particularly to one with a flexible sealing collar that tightly seals against the inside diameter of plastic pipe such as P.V.C. electrical conduit, referred to as the pipe from here on, preventing the loss of pressure that builds up in the pipe when it is heated for the purpose of bending the pipe during installation.

The pressure sealing plug will be made to fit the inside diameter for a variety of different pipe sizes from 1 inch to 6 inches. If the pressure that is produced by heating the pipe escapes then the pipe will collapse and/or kink and render the pipe useless. With the pressure contained in the pipe by having one pressure sealing plug inserted and tightened at each end of the pipe, bending of the pipe by a skilled installer is made much easier. At present an installer must modify a blank duct plug (U.S. Pat. No. 4,968,197) by sanding or grinding the top disc to a smaller diameter so it will fit within the inside diameter of the pipe. Sometimes the pressure blows the blank duct plugs free as there is no good means or tool to get them tight enough and the pressure sealing plug will produce a safer pressure seal. The pressure sealing plug will be inserted past the pipe end that is belled for receiving the next length of pipe, and on the other end the pressure sealing plug will be placed far enough inside the pipe so the factory end of the pipe is not compromised, allowing the next pipe to fit together properly after the bend or bends have been accomplished.

### BRIEF SUMMARY OF THE INVENTION

It is therefore, the main object of the present invention to provide a pressure seam plug which is convenient to install inside and remove from the pipe.

Another object of the present invention is to provide a pressure sealing plug which is easy to assemble with component parts that do not break away from each other when they are connected together for use.

A yet further object of the present invention is to provide a pressure sealing plug which has a flexible sealing collar so as to expand at the upper end of the sealing collar according to the inside diameter of the pipe, to tightly seal past the mouth of the pipe so as to prevent the escape of pressure produced when the pipe is heated when necessary to bend the pipe for correct and proper installation.

According to the present invention, a pressure sealing plug is generally comprised of a bottom plate and/or block with a threaded chef screw means, a flexible sealing collar mounted on the bottom plate and/or block with the threaded shaft screw means, through the flexible sealing collar, then through the center of the top plate and/or block that has an angled and/or chamfered surface and a hole through the center that is placed on top of the sealing collar. The T handle has female threads inside the bottom end which is then placed through the center hole of tie top plate and/or block and is screwed onto the threaded shaft screw means of the bottom plate and/or block. The upper end of the flexible sealing collar be forced outward and expands uniformly when the T handle is tightened, which forces the top plate and/or block towards the bottom plate and/or block. At this time all parts of the pressure sealing plug are assembled, referred to as plug from here on. Once the plug is inserted into the pipe screwing the T handle onto the threaded screw means, the top of the flexible sealing collar is forced against the inside diameter of the pipe forming a pressure seal. When a pressure sealing plug is installed and tightened inside each end of a length of the pipe, the pipe can then be heated and bent.

The above objects, features, and advantages of the present invention will be fully understood from the following detailed description of the preferred embodiment considered in connection with the annexed drawing in which:

Drawing 1. The drawing shows a perspective fragmentary view of a pressure sealing plug embodying the present invention.

### DETAILED DESCRIPTION OF THE PREFERRED EMBODIMENT

Turning now to the attached drawing in detail; illustrated therein is a pressure sealing plug embodying the present invention and generally comprised of a circular bottom plate and/or block (1) having a circular smaller diameter shaft (2) integrally projecting upward and also having male threads or screw means (3) and notched at its top side (11), a flexible sealing collar (4), an angled face (5) of the circular top pressure plate and/or block (6), and a T handle (7) with receiving threaded or screw means (9) integrally; also having a circular striker plate means (8) integrally outward with a smaller outside diameter than the circular top pressure plate and/or block (6).

Referring to the Drawing, is a circular bottom plate and/or block: (1) with a smaller integral circular vertical shaft from the center of the circular bottom plate and/or block (2) having male threads providing the male threaded screw means (3). On the top side of the circular bottom plate and/or block (1) is a somewhat smaller integral diameter portion that projects upwards and provides a notched surface (11), a flexible sealing collar (4) that is of such diameter as to pass through the inside diameter of the pipe and just fits around and onto the notched portion (11) of the bottom circular plate and/or block (1) by passing over and through the circular vertical shaft (2) and also the male threaded means (3), a circular top pressure plate and/or block (6) having a smaller diameter at its bottom side forming a chamfer or angled face (5) to contact the flexible sealing collar (4) with a through hole (10) in the center that provides access to the male treaded means (3) and a T handle (7) that has receiving female threads or screw means inside the center of its bottom end (9) into the bottom end with a striker plate and/or block (8) that is integral and projects outward from the T handle (7) with an outside diameter that is smaller than the circular top pressure plate and/or block (6) that provides slippage by design. The T handle (7) is of sufficient length so as to reach past the belied end, and also the other factory end of a length of pipe with room so the installer can turn the T handle (7) and not scrape his fingers against the end of the pipe.

Referring to the Drawing, when in assembly, the flexible sealing collar (4) is placed over the male threaded maw (3) and also the vertical shaft (2), then stretched onto the circular notched bottom a (11) of the bottom plate and/or block (1), then resting on top of the circular bottom plate and/or block (1) while the circular top pressure plate and/or block (6) is placed on top of the flexible sealing collar (4) with the through center hole (10) towards the male threaded means (3), then the handle (7) is placed through the through center hole (10) with its bottom end having receiving female threaded means (9). By turning the handle (7) in the clockwise direction the male threaded means (3) threads into the female threaded means (9) and passes through the through center hole (10) until the circular striker plate and/or block (8) strikes against and on top of the circular top pressure plate and/or block (6) and forces the circular top pressure plate and/or block (6) onto and against the top edge of the flexible sealing collar (4). Continuing to turn the T handle (7) in the clockwise direction the circular top pressure plate and/or block (6) with its chamfered or angled surface (5) causes the top edge of the flexible sealing collar (4) to expand outward uniformly.

When in use, when two pressure sealing plugs are placed inside opposite ends of a length of pipe the top edge of the sealing collars (4) are then pressed against the inside surface of the pipe, and continuing to turn the T handles (7) in the clockwise direction provides enough sealing force that the pressure produced when the pipe is heated, for the purpose of bending and/or re-shaping the pipe, is contained and sealed off. The pressure is not allowed to escape, and it is this pressure that allows the pipe to be bent or re-shaped by a skilled installer without kinking or collapsing the inside diameters of the pipe. By turning one T handle (7) in the counter-clockwise direction after the pipe has cooled enough to retain its shape, un-threading the male threaded means, (3) and the female threaded means (9), the top pressure plate and/or block (6) will then move in the upward direction allowing the sealing collar (4) to return to its original shape and diameter than releasing the pressure contained inside the pipe. At the same time, the installer should hold onto the T handle (7) with enough force that when the pressure is released from the inside of the pipe the plug that is held in place so it will not shoot or pop out of the pipe as the blank duct plugs do that are currently used, causing a safety concern in the field or place of installation.

Referring to the Drawing, the circular bottom plate and/or block (1), the smaller diameter shaft (2), the male threaded means (3), the circular top pressure plate and/or block (6), the T handle (7), the striker plate and/or block (8), and the female threaded means (9) are to be made of rigid materials such as iron, non-ferrous metal, rigid plastics, or tooled steel by means of machining, injection molding, or the aft of tool making. The flexible sealing culler (4) is to be made of rubber, silicone, silicone and rubber combined, or any other material that is flexible and will provide a tight enough seal against the inside diameter of the pipe. The flexible sealing collar may be made by the means of injection molding, extruding, casting, etc.

What is claimed is:

1. A pressure sealing plug:
Insert one said plug into and past the said belied end of said pipe, then tighten said plug against the inside diameter of said pipe. Now insert the second said plug into and past the opening and opposite end of said pipe, then tighten said plug against the inside diameter of said pipe. The two said plugs will prevent said pressure inside said pipe when said pipe heated up for the purposes of bending and or re-shaping of said pipe. When two said plugs are used to seal said pressure inside said heated pipe the captured said pressure aids the said pipe to retain its uniform said inside diameter while the two said plugs provide the installer a much safer said means than said present said blank duct plugs can provide.
